(19) United States
(12) Patent Application Publication
(10) Pub. No.: US 2008/0013930 A1
(43) Pub. Date: Jan. 17, 2008

(54) FLUID HEATING APPARATUS AND FLUID TREATMENT APPARATUS USING THE SAME

(75) Inventor: Maki HAMAGUCHI, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/773,069

(22) Filed: Jul. 3, 2007

(30) Foreign Application Priority Data
Jul. 11, 2006 (JP) 2006-190474

(51) Int. Cl. H05B 3/12

(52) U.S. Cl. 392/320

(57) ABSTRACT

A fluid heating apparatus is provided, which can efficiently heat a fluid to be heated without contaminating the fluid. The fluid heating apparatus has a heating room including a magnetic-flux permeable material, and having an inlet for introducing a fluid to be heated, and an outlet for exhausting a heat-treated fluid; a plurality of glassy carbon fillers filled in the heating room, each of which is partially or wholly formed in a shape of curved surface or protrusion; and an induction coil disposed outside the heating room for inductively heating the glassy carbon fillers.

### BACKGROUND OF THE INVENTION

1. Field of the Invention

The present invention relates to a fluid heating apparatus for heating liquid or gas using an induction heating phenomenon, and a fluid treatment apparatus using the same.

2. Description of the Related Art

Usually, various heating units such as a multi-tube heat exchanger or jacket heater are known as a unit for heating a fluid, and the heating units are roughly classified into a type using a hot heating medium and a type using a resisting heating element.

In the multi-tube heat exchanger, since a fluid to be heated cannot be directly contacted to a heating medium, some diaphragm is needed. However, the diaphragm causes heat transfer resistance, consequently heating efficiency is inevitably reduced.

On the other hand, in the jacket heater, since a resisting heating element and an electrode or a wire for supplying a current to the heating element are directly contacted to the heating medium, while heating efficiency is high compared with the multi-tube heat exchanger, a difficulty such as contamination in fluid to be heated or degradation in heated portion tends to occur.

As a heating unit different from these, a unit using a heating phenomenon of a material due to a high frequency current, so-called induction heating apparatus is given. The induction heating apparatus has advantages that rapid heating is possible, and the difficulty of contamination or degradation due to a power supply because a heating element is separated from the power supply by a space.

However, an induction heating element made of metal or graphite, which has been frequently used in the induction heating apparatus, has the following difficulty. That is, the metal heating element has a difficulty of corrosion of metal, and the graphite heating element has a property of easily changing into particles, therefore each of them may contaminate a fluid to be heated.

Thus, a heating element formed by tubularly forming glassy carbon is given as an induction heating element other than the metal or graphite heating element (for example, see Japanese Unexamined Patent Application Publication No. 2003-151737).

Such an induction heating apparatus is configured such that a glassy carbon cylindrical body is disposed in a reactor vessel, and the glassy carbon cylindrical body in the reactor vessel is heated by a high frequency induction coil disposed outside the reactor vessel, so that a silicon wafer in the reactor vessel is heated.

When the glassy carbon cylindrical body is used for the heating element, an advantage is given, that is, corrosion resistance is excellent compared with metal or graphite. However, while the induction heating apparatus is suitable for heating treatment of a silicon wafer as a solid in a stationary state, it is insufficient in heating efficiency for use in heating a fluid which naturally flows.

### SUMMARY OF THE INVENTION

In view of foregoing, the present invention aims at providing a fluid heating apparatus and a fluid treatment apparatus that can efficiently heat a fluid to be heated without contaminating the fluids.

A fluid heating apparatus of one aspect of the invention is summarized by having a heating room including a magnetic-flux permeable material, and having an inlet for introducing a fluid to be heated, and an outlet for exhausting a heat-treated fluid; a plurality of glassy carbon fillers filled in the heating room, each of which is partially or wholly formed in a shape of curved surface or protrusion; and an induction coil disposed outside the heating room for inductively heating the glassy carbon fillers.

According to the fluid heating apparatus of the aspect of the invention, the fluid to be heated introduced into the heating room moves through the heating room flowing through gaps between the plurality of glassy carbon fillers being filled while being contacted to the fillers, so that the fluid is efficiently heated.

In the fluid heating apparatus of the aspect of the invention, as the glassy carbon fillers, hollow or solid fillers formed in a spherical or columnar shape can be used. In the case of using the hollow glassy carbon filler, when a hole in communication with the inside of the filler is formed, the fluid to be heated flows even into the inside of the glassy carbon filler, leading to further improvement in heat exchange efficiency.

Moreover, the glassy carbon fillers are used, thereby an induction heating element can be made, which is high in chemical durability, and hardly to change into particles compared with the case of using other carbon materials, graphite and the like.

Moreover, each of the glassy carbon fillers may have an insulating coating on a surface thereof, and ceramics can be used for the insulating coating.

While the induction coil is preferably disposed with being wound around the heating room, it may be disposed with being adjacent to the heating room.

As an example of the fluid to be heated, gas, pure water or steam is shown.

The fluid treatment apparatus of the aspect of the invention is summarized by including the fluid heating apparatus having a configuration as above, and a supply unit of a fluid to be heated, the unit being connected to the inlet of the heating room of the fluid heating apparatus, and supplying a fluid to be heated to the heating room, the fluid having a controlled flow rate.

According to the fluid treatment apparatus of the aspect of the invention, since the fluid to be heated, which has a controlled flow rate, is continuously supplied into the heating room and heated in the heating room, then exhausted for a subsequent process, the fluid can be subjected to in-line heating treatment.

According to the fluid heating apparatus of the aspect of the invention, since the fluid to be heated is contacted to the plurality of glassy carbon fillers, the fluid to be heated can be efficiently heated without being contaminated.

According to the fluid treatment apparatus of the aspect of the invention, the fluid can be efficiently heated in an in-line manner.

### BRIEF DESCRIPTION OF THE DRAWINGS

FIG. 1 is a longitudinal section view showing a configuration of a fluid heating apparatus according to an embodiment of the invention;

FIG. 2 is a perspective view for explaining a method of manufacturing a hollow sphere as a glassy carbon filler;

FIG. 3 is a perspective view showing a cylinder as a glassy carbon filler;

FIG. 4 is a view corresponding to FIG. 1 showing a configuration of a usual fluid heating apparatus as a comparative example;

FIG. 5 is a perspective view showing a modification of the glassy carbon filler;

FIG. 6 is a block diagram showing a configuration of a pure water heating apparatus as a fluid treatment apparatus of an embodiment of the invention; and

FIG. 7 is a block diagram showing a configuration of a gas heating apparatus as a fluid treatment apparatus of an embodiment of the invention.

### DESCRIPTION OF THE PREFERRED EMBODIMENT

Hereinafter, an embodiment of the invention will be described in detail according to an embodiment as shown in drawings.

As one susceptor for the induction heating apparatus, a susceptor made of glassy carbon has been used, and for example, one disk-like susceptor or one cylindrical susceptor is disposed in a heating room, then the susceptor is heated, thereby an object to be heated set on the disk-like susceptor or in the cylindrical susceptor is indirectly heated by radiant heat from the susceptor. The susceptor means a component or a material that heats upon receiving energy of a high frequency magnetic field.

Since this type of induction heating apparatus aims to heat a solid such as silicon wafer as an object to be heated, when a fluid moving at a large space velocity is an object to be heated, it has been insufficient in heating efficiency.

As one reason for it, a large induction current cannot be flown to the susceptor because of insufficient volume of the susceptor. Furthermore, surface area obtained by the one disk-like susceptor or one cylindrical susceptor is limited, thereby heat exchange efficiency cannot be improved between the susceptor and a fluid passing through the susceptor.

Therefore, the susceptor was tried to be improved, for example, volume of the usual disk-like or cylindrical susceptor, or thickness of such a susceptor was tried to be increased. However, it was found that even if the susceptor was tried to be improved by extension of a usual configuration, efficiency in heating of a fluid was hard to be improved.

This is considered to be because, in induction heating, even if a susceptor is merely increased in size, the inside of the susceptor hardly heats due to a skin effect (a phenomenon that an induction current induced in an object to be heated is largely concentrated on a surface, and abruptly decreased with increase in distance from the surface), or surface area per unit volume of a susceptor cannot be increased.

On the contrary, the fluid heating apparatus of an embodiment of the invention has a configuration significantly different from a configuration of the usual susceptor, wherein a plurality of separated fillers acting as susceptors are filled in the heating room.

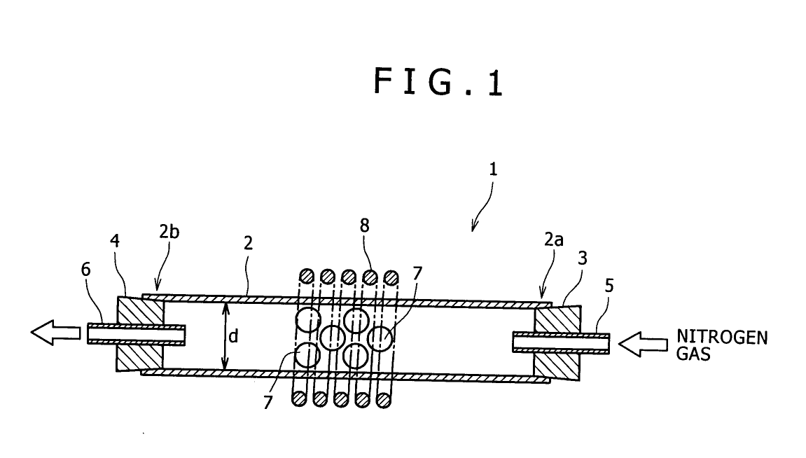

FIG. 1 shows an embodiment of the fluid heating apparatus of the invention.

In the figure, a fluid heating apparatus 1 has a heating room 2 including quartz, and one end 2a of the heating room 2 is closed by a rubber plug 3, and the other end 2b is similarly closed by a rubber plug 4 respectively.

The rubber plug 3 has an introduction pipe 5 for introducing nitrogen gas, and the rubber plug 4 has an exhaust pipe 6 for exhausting heat-treated nitrogen gas, in a penetrating manner respectively.

A plurality of glassy carbon fillers 7 are filled in the heating room 2, and each of the glassy carbon fillers 7 acts as a susceptor.

The glassy carbon fillers 7 are obtained by using thermosetting resin as a source material, then curing the resin, and then carbonizing the resin by combusting it in an inert gas atmosphere or in a vacuum, can be manufactured by a known technique.

Specifically, for example, phenol resin is molded into a desired shape using a molding die, then subjected to heat treatment at a high temperature (typically, 1000° C.) under an inert gas atmosphere to be carbonized and thus formed into a glassy carbon compact, and then the compact is subjected to machining as needed, thereby the glassy carbon fillers 7 can be obtained. Alternatively, an appropriate glassy carbon compact may be subjected to machining to obtain the glassy carbon fillers 7 in a desired shape.

The glassy carbon fillers 7 may be in a shape of solid sphere or hollow sphere. In the case of the hollow sphere, an advantage is given, that is, use efficiency of a material is improved.

Moreover, when each of the fillers is formed in the shape of hollow sphere, and has a hole in communication with the inside of the hollow sphere, a fluid to be heat-treated enters even into the inside of the glassy carbon filler 7, consequently higher heat exchange efficiency can be obtained. As the hole, a hole can be formed at one point in the glassy carbon filler 7, or two holes can be formed at two points in the filler in a penetrating manner along diameter.

As a method of manufacturing a spherical compact of thermosetting resin, which is a precursor of the spherical or hollow spherical glassy carbon filler 7, first two semispherical or hollow semispherical compacts are obtained by cast molding, press molding, injection molding or the like, then the two compacts are joined together, thereby the spherical compact can be manufactured. An appropriate core may be used during molding.

When the glassy carbon filler 7 having the hole is manufactured, drilling may be performed using a drill or the like in a stage of the thermosetting resin spherical compact, or may be performed after the compact is glassy-carbonized.

A shape of the glassy carbon filler 7 is not necessarily a sphere, and may be a spheroid, or an irregularly distorted sphere. Furthermore, a filler in a shape of cylinder or column shape can be used in addition to the sphere. However, each of the glassy carbon fillers 7 needs to partially or wholly have a curved surface so that when the glassy carbon fillers 7 are contacted to each other, contact area between them is minimized.

This is because if the glassy carbon fillers are surface-contacted to each other, an induction current flows over a plurality of glassy carbon fillers, and the skin effect is induced and thus an induction heating effect is reduced. Therefore, a glassy carbon filler 7 in an optional shape can be used for the susceptor, as long as it partially or wholly has a curved surface.

As the glassy carbon fillers 7 filled in the heating room 2, not only fillers having the same shape, but also fillers having different sizes may be filled, or fillers having different shapes may be mixedly filled.

As a size of the glassy carbon fillers 7 filled in the heating room 2, when inner diameter of the heating room 2 is assumed to be d, the size is desirably larger than 1/50d, and smaller than ½d.

When the size is lower than 1/50d, an electric conduction rate between the glassy carbon fillers 7 is increased, as a result, the fillers do not act as independent susceptors, but act as an aggregate, thereby the skin effect is induced and in turn induction heating efficiency is reduced.

On the other hand, when the size is more than ½d, a plurality of the glassy carbon fillers 7 are hard to be disposed in the heating room 2 and thus the volumetric filling rate of susceptors cannot be increased, thereby the induction heating efficiency is reduced. The number of the glassy carbon fillers 7 filled in the heating room 2 is preferably 5 to 100 based on the number within a range as above.

As shown in FIG. 1, an induction coil 8 is spirally disposed around the heating room 2 in a region where the glassy carbon fillers 7 are filled, and the induction coil 8 can be connected to a not-shown high frequency AC power supply.

Next, a method of manufacturing the glassy carbon fillers 7 in various shapes is described.

### Example of Manufacturing Glassy Carbon Fillers 7

a) Hollow Sphere

A stainless semispherical cup 30 mm in inner diameter and a synthetic resin spherical core 25 mm in outer diameter were used for molding.

The spherical core was disposed within the semispherical cup with a gap of 2.5 mm between them, then commercial liquid phenol resin (PL-4804, manufactured by GUNEI CHEMICAL INDUSTRY CO., LTD.) was filled into the gap, and then kept at 100° C. for 10 hr, and then removed from the cup and core as dies, so that a semispherical phenol resin compound was obtained.

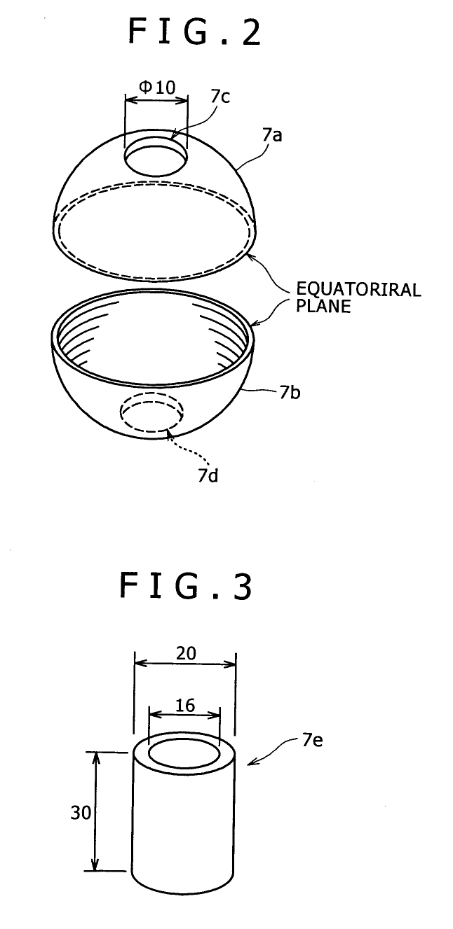

Next, as shown in FIG. 2, equatorial planes of two semispherical phenol resin compounds obtained by the above method were opposed, and adhered to each other using the same liquid phenol resin as above so that a spherical body was formed.

The spherical body was heated at 250° C. for 50 hr to be perfectly cured, then holes 7c, 7d 10 mm in diameter were provided in regions corresponding to a north pole and a south pole of the spherical body.

Next, the spherical body was subjected to heat treatment at 1000° C. for 5 hr in a nitrogen atmosphere to be carbonized, and finally a glassy carbon hollow sphere was obtained, which is 25 mm in outer diameter and 2 mm in thickness, and has holes 7c, 7d.

b) Cylinder

The phenol resin used for manufacturing the hollow sphere was used, and subjected to centrifugal molding using a centrifugal molding machine having a cylindrical die 25 mm in inner diameter and 500 mm in length, so that a phenol resin cylinder 24 mm in outer diameter and 450 mm in length was obtained. The cylinder was carbonized at the same condition as that in manufacturing the hollow sphere, so that a cylinder 20 mm in outer diameter, 16 mm in inner diameter, and 350 mm in length was obtained. The cylinder was cut into pieces 30 mm in length, and finally a glassy carbon cylinder 7e as shown in FIG. 3 was obtained.

An insulating coating was formed on a surface of the hollow sphere or the cylinder.

As a material of the coating, a silica coating agent, ALCEDAR COAT, manufactured by Clariant (Japan) K. K. was used.

An outer surface of the glassy carbon hollow sphere or cylinder manufactured according to a procedure as above was roughened by being polished with sandpaper of #400, then 5 wt % xylene solution of ALCEDAR COAT was coated on the roughened surface.

The sphere or cylinder was heated at 150° C. to dry the coated film (remove solvent), and furthermore heated at 4000° C. in air to bake the coating.

Thickness of an obtained silica coating layer was about 5 μm.

c) Glassy Carbon Tube as a Comparative Example

The phenol resin used for manufacturing the hollow sphere was used, and subjected to centrifugal molding using a centrifugal molding machine having a cylindrical die 70 mm in inner diameter and 400 mm in length, so that a thermosetting resin tube 68 mm in outer diameter and 380 mm in length was obtained. The resin tube was heated at 250° C. for 50 hr to be perfectly cured, then the cylinder was subjected to heat treatment at 1000° C. in a nitrogen atmosphere to be carbonized, and finally a glassy carbon tube 58 mm in outer diameter, 2 mm in thickness, and 100 mm in length was obtained.

### Comparison Test on Heating Property

A water-cooled copper tube 6 mm in outer diameter was spirally wound 5 times with an inner diameter of 70 mm and a coil pitch of 10 mm, and the wound copper tube was used for the induction coil 8 (see FIG. 1).

A quartz tube 65 mm in outer diameter and 250 mm in length, of which both ends are opened, was disposed within the induction coil 8 as the heating room 2 so as to be concentric with the coil. Then, gas temperature was measured at each of an inlet side and an outlet side of the heat treatment room while nitrogen gas was flown at a certain flow rate.

Nitrogen gas was introduced into the heating room 2 at a line speed of 0.5 m/sec, and high frequency power was applied to the induction coil 8 at a condition of frequency of 430 kHz, output power of 1.2 kW, and a current of 6 A.

a′) Case of Using Hollow Sphere

The glassy carbon fillers 7 including the hollow sphere manufactured by the manufacturing method of the above a) were filled in the heating room 2. In a filling method of them, 9 fillers were filled, of which the total weight was 54 g, and the total surface area was 360 cm².

b′) Case of Using Cylinder

The glassy carbon fillers 7 including the cylinder manufactured by the manufacturing method of the above b) were filled in the heating room 2. In a filling method of them, 10 fillers were filled, of which the total weight was 51 g, and the total surface area was 351 cm².

c′) Case of Using Glassy Carbon Tube as Comparative Example

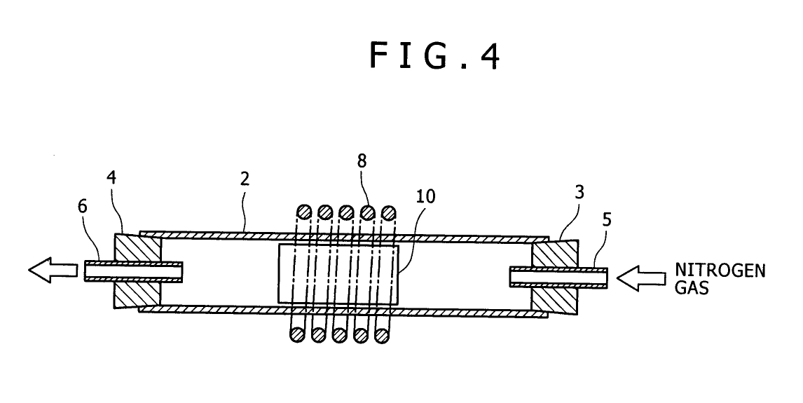

One glassy carbon tube 10 manufactured by the manufacturing method of the above c) was inserted into the heating room 2, as shown in FIG. 4. The weight of the tube was 54 g, and the total surface area was 360 cm². Configurations other than the glassy carbon tube 10 were the same as in FIG. 1.

TABLE 1
(Results of measurements)

| | Inlet | Outlet |
|---|---|---|
| Type of heating element | temperature (° C.) | temperature (° C.) |
| a′) a plurality of filled hollow | 25 | 259 |
| spheres (φ25 mm) | | |
| b′) a plurality of filled | 25 | 237 |
| cylinders (φ20 mm, 30 mm L) | | |
| c′) one glassy carbon tube | 25 | 108 |
| (φ58 mm, 100 mm L) | | |

As known from the measurement results, it was able to be confirmed that, according to the fluid heating apparatus in which a plurality of hollow spherical or cylindrical, glassy carbon fillers 7 of an embodiment of the invention were filled in the heating room 2 as susceptors, heating efficiency was significantly improved, while a heating element had approximately the same weight and heat transfer area as those of the usual heating element using the glassy carbon tube.

Therefore, when the number of the glassy carbon fillers 7 of an embodiment of the invention to be filled into the heating room 2 is further increased, heating efficiency can be further improved.

While the induction coil 8 was spirally wound around the heating room 2 in the embodiment, it can be disposed with being adjacent to the heating room 2.

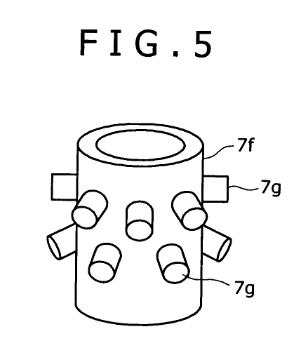

FIG. 5 shows a modification of the glassy carbon filler 7.

The glassy carbon filler 7 as shown in the figure is made by forming a plurality of projections 7g on an outer wall of a trunk of a cylindrical portion 7f.

In the fillers having the projections 7g in this way, when the glassy carbon fillers 7 are filled in the heating room 2, a predetermined gap is secured between adjacent glassy carbon fillers 7, consequently each of the glassy carbon fillers 7 can be kept in a separated manner.

In this way, the glassy carbon fillers 7 are preferably filled in the heating room 2 in an irregular filling condition. Moreover, as each of the glassy carbon fillers 7, if irregular filling is obtained in a separated condition, a filler having a surface structure configured by a curved surface such as Raschig ring can be used.

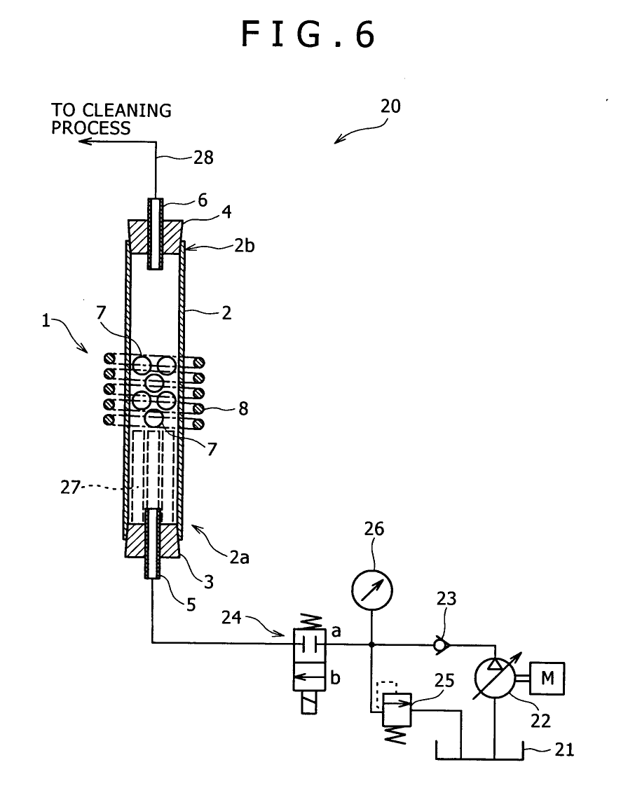

FIG. 6 shows a configuration of a pure water heating apparatus as a fluid treatment apparatus using the fluid heating apparatus 1.

In the figure, the same components as in FIG. 1 are marked with the same references, and omitted to be described.

The pure water heating apparatus 20 as shown in FIG. 6 performs heating treatment for the purpose of improving cleaning efficiency of pure water used for anti-corrosion treatment after etching treatment of a semiconductor, or for cleaning of a liquid crystal device.

Pure water, which was pumped up from a pure water tank 21 storing pure water via a pump 22 of a variable flow rate type, is introduced to a switching valve 24 through a check valve 23.

The switching valve 24 has a shutoff position A and a communication position B, and when it is switched to the communication position B, it supplies the pure water to the fluid heating apparatus 1. A reference 25 shows a relief valve for keeping a circuit pressure at a predetermined value, and 26 shows a pressure gage.

The pure water tank 21, pump 22, and relief valve 25 act as a unit for supplying a fluid to be heated.

The pure water introduced into the heating room 2 through the introduction pipe 5 flows through many channels formed in a lotus-root-like ceramic support 27, then flows into many glassy carbon fillers 7 held on the support 27.

Since the glassy carbon fillers 7 heats by the induction coil 8 applied with high frequency power, the pure water flowing through gaps between the glassy carbon fillers 7 is subjected to heat exchange by contacting to the glassy carbon fillers 7.

The pure water is further heated during moving up between the plurality of glassy carbon fillers 7 being filled, then the pure water, which was heated to a predetermined temperature by passing through layers of the glassy carbon fillers 7, is sent out to the outside of the heating room 2 through the exhaust pipe 6, and then sent for a cleaning process as a next process through piping 28.

In this way, the fluid heating apparatus 1 of an embodiment of the invention can be applied to heating not only gas such as inert gas, but also liquid such as pure water. According to the pure water heating apparatus having a configuration as above, pure water can be stably and continuously heated in an in-line manner, consequently heating efficiency of pure water is improved, in addition, a pure water heating apparatus can be simply configured.

As an apparatus for food processing or various types of heat treatment, a superheated steam generator of an induction heating type is known. In this type of apparatus, for example, saturated vapor (steam) from a boiler is introduced into a heating room, and allowed to pass through a metal heating element, which heats by high frequency induction heating, thereby temperature of the saturated vapor is further increased so that the vapor is exhausted as superheated steam.

When the fluid heating apparatus 1 of an embodiment of the invention having high heating efficiency is applied to such a superheated steam generator, superheated steam can be generated in a smaller-scale configuration.

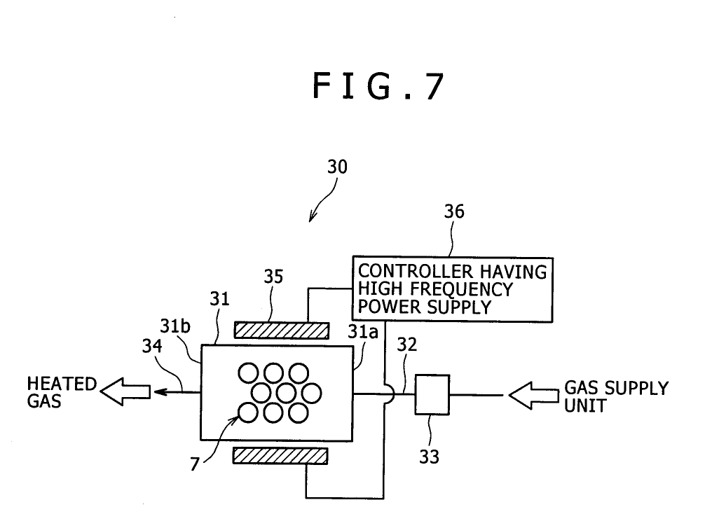

Next, FIG. 7 shows a block diagram showing a configuration in the case that the fluid treatment apparatus of an embodiment of the invention is applied to heating of gas.

A gas heating apparatus 30 as shown in the figure has a cylindrical, heating element housing vessel 31 including quartz, and a plurality of glassy carbon fillers 7 as above are filled in the heating element housing vessel 31. Each of the filled glassy carbon fillers 7 acts as a susceptor.

One end 31a and the other end 31b of the heating element housing vessel 31 are closed in an openable manner by a closing member such as rubber plug having a through-hole respectively.

An inlet at the one end 31a is connected with an introduction pipe 32 for introducing a gas to be heated, and the introduction pipe 32 is connected with a not-shown gas supply apparatus (gas supply unit) via a flow rate regulator 33 for regulating a flow rate of the gas to be heated.

As the gas supply apparatus, specifically, a gas cylinder storing nitrogen gas or the like is shown, and when a gas is in a liquid state at normal temperature (for example, chlorine trifluoride ClF₃), the gas supply apparatus further includes a gas vaporizer.

An outlet at the other end 31b is connected with an exhaust pipe 34 for exhausting the heated gas.

An induction coil 35 is spirally wound around the heating element housing vessel 31, and the induction coil 35 is connected to a controller 36 having high frequency AC power supply.

In the gas heating apparatus 30, while the glassy carbon fillers 7 are allowed to heat by Joule heat using an induction current, a gas to be heated is sent to the heating element housing vessel 31, and subjected to heat exchange with the glassy carbon fillers 7, thereby the gas to be heated is heated to a desired temperature, and the heated gas for treatment is sent out through an exhaust pipe 34 at the other end 31b.

According to the pure water heating apparatus 20 and the gas heating apparatus 30, a fluid to be heated can be efficiently heated in an in-line manner.

It should be understood by those skilled in the art that various modifications, combinations, sub-combinations, and alternations may occur depending on the design requirements and other factors insofar as they are within the scope and spirit of the appended claims or the equivalents thereof.

What is claimed is:

1. A fluid heating apparatus, comprising:
a heating room including a magnetic-flux permeable material, and having an inlet for introducing a fluid to be heated, and an outlet for exhausting a heat-treated fluid,
a plurality of glassy carbon fillers filled in the heating room, each of which is partially or wholly formed in a shape of curved surface or protrusion, and
an induction coil disposed outside the heating room for inductively heating the glassy carbon fillers.

2. The fluid heating apparatus according to claim 1,
wherein each of the glassy carbon fillers is formed in a hollow or solid, spherical or columnar shape.

3. The fluid heating apparatus according to claim 2,
wherein each of the hollow glassy carbon fillers has a hole formed therein, the hole being in communication with the inside of the filler.

4. The fluid heating apparatus according to claim 3,
wherein each of the glassy carbon fillers has an insulating coating.

5. The fluid heating apparatus according to claim 4,
wherein the insulating coating includes ceramics.

6. The fluid heating apparatus according to claim 1,
wherein the induction coil is wound around the heating room, or disposed with being adjacent to the heating room.

7. The fluid heating apparatus according to claim 6,
wherein the fluid to be heated is gas.

8. The fluid heating apparatus according to claim 6,
wherein the fluid to be heated is pure water or steam.

9. A fluid treatment apparatus, comprising:
the fluid heating apparatus according to claim 7, and
a supply unit of a fluid to be heated, the unit being connected to the inlet of the heating room of the fluid heating apparatus, and supplying a fluid to be heated to the heating room, the fluid having a controlled flow rate.

10. A fluid treatment apparatus, comprising:
the fluid heating apparatus according to claim 8, and
a supply unit of a fluid to be heated, the unit being connected to the inlet of the heating room of the fluid heating apparatus, and supplying a fluid to be heated to the heating room, the fluid having a controlled flow rate.
